(19) United States
(12) Patent Application Publication
(10) Pub. No.: US 2016/0145138 A1
(43) Pub. Date: May 26, 2016

(54) MANUFACTURING METHOD OF CURVED DISPLAY DEVICE

(71) Applicant: Samsung Display Co., Ltd., Yongin-City (KR)

(72) Inventors: Hoi Kwan LEE, Anseong-si (KR); Seung Ho KIM, Asan-si (KR); Seung KIM, Seongnam-si (KR); Ik Hyung PARK, Suwon-si (KR); Jong Hoon YEUM, Seoul (KR)

(21) Appl. No.: 14/657,481

(22) Filed: Mar. 13, 2015

(30) Foreign Application Priority Data
Nov. 26, 2014 (KR) 10-2014-0166437

(51) Int. Cl. C03B 23/023

(52) U.S. Cl. CPC C03B 23/0235

(57) ABSTRACT

The present inventive concept provides to a manufacturing method of a curved display device including: bending a substrate to form a curved surface; heat-treating the substrate formed with the curved surface; restoring the heat-treated substrate to a flat state; forming display elements on the substrate; and bending the substrate of the flat state to form the curved surface. According to the present inventive concept, by performing the preliminary heat treatment to the glass substrate, durability and reliability of the curved panel may be improved.

### CROSS-REFERENCE TO RELATED APPLICATION

This application claims priority to and the benefit of Korean Patent Application No. 10-2014-0166437 filed in the Korean Intellectual Property Office on Nov. 26, 2014, the entire contents of which are incorporated herein by reference.

### BACKGROUND

(a) Field

The present inventive concept relates to a manufacturing method of a curved display device, and in detail, relates to a manufacturing method of a curved display device that improves durability and reliability of a curved glass substrate through a preliminary heat treatment.

(b) Description of the Related Art

Recently, a liquid crystal display (LCD) and an organic light emitting diode (OLED) display have been most widely used for flat panel display.

The liquid crystal display displays images by applying voltages to the field-generating electrodes to generate an electric field in a liquid crystal (LC) layer that determines the orientations of LC molecules therein to adjust polarization of incident light. Differently from the liquid crystal display, the organic light emitting diode device has a self-light emitting characteristic, does not require a separate light source, and displays an image through a display substrate in which a thin film transistor and an organic light emitting element are formed.

This display device is used as a display device of a television receiver, of which a size of a screen is being enlarged. When the size of the display device is enlarged, a difference in the visual field increases when a viewer views a center portion of the screen and when the viewer views both left and right ends of the screen.

To compensate for such difference in the visual field, it is possible to form a display device in a curved shape by bending the display device to be in a concave shape or a convex shape. The display device may be provided as a portrait type having a longer vertical length than a horizontal length and bent in a vertical direction, and may be provided as a landscape type having a shorter vertical length than a horizontal length and bent in a horizontal direction.

However, in the case of forming the curved shape by bending the display device, a compressive stress is applied to the concave side of the curved surface and a tensile stress is applied to the convex side of the curved surface of the substrate. Accordingly, a crack may be generated in the substrate and the panel may be damaged by the crack.

The above information disclosed in this Background section is only for enhancement of understanding of the background of the inventive concept and therefore it may contain information that does not form the prior art that is already known in this country to a person of ordinary skill in the art.

### SUMMARY

The present inventive concept provides a manufacturing method of a display device that improves durability and reliability of a curved display device through a preliminary heat treatment of a glass substrate.

An exemplary embodiment of the present inventive concept provides to a manufacturing method of a curved display device including: bending a substrate to form a curved surface; heat-treating the substrate formed with the curved surface; restoring the heat-treated substrate into a flat state; forming display elements on a substrate; and bending the substrate of the flat state to form the curved surface.

The substrate may be made of a glass.

In the step of heat-treating the substrate, the surface where a tensile stress is generated may be heat-treated.

In the step of heat-treating the substrate, a convex surface of the substrate may be heat-treated.

The heat treatment of the substrate may be a wet heat treatment.

The wet heat treatment may use a vapor.

The wet heat treatment using the vapor may be performed at a temperature of about 200-600° C.

The wet heat treatment using the vapor may be performed for about 10-30 minutes.

The heat treatment of the substrate may be a dry heat treatment.

The dry heat treatment may use radiation heat.

The dry heat treatment may be performed at a temperature of about 600-800° C.

The dry heat treatment using the radiation heat may be performed for about 10-30 minutes.

The heat-treating of the substrate is a high frequency treatment.

The high frequency treatment uses a variable frequency microwave (VFM) or a laser.

Another exemplary embodiment of the present inventive concept provides a method for manufacturing a curved display device includes: bending a glass substrate to form a curved surface; heat-treating a surface in which a tensile stress is generated in the glass substrate formed of the curved surface; restoring the heat-treated glass substrate to a flat state; forming display elements on a glass substrate; and bending the substrate of the flat state to form the curved surface.

As described above, the present inventive concept performs the preliminary heat treatment to the glass substrate, thereby improving the durability and the reliability of the curved panel.

### BRIEF DESCRIPTION OF THE DRAWINGS

FIG. 1 is a flowchart showing a manufacturing method of a curved display device according to an exemplary embodiment of the present inventive concept.

FIGS. 2, 3 and 4 are views sequentially showing a manufacturing method of a curved display device according to an exemplary embodiment of the present inventive concept.

FIG. 5 is a graph showing test results of a curved display device according to an exemplary embodiment of the present inventive concept.

FIG. 6 is a schematic cross-sectional view of a curved display device according to an exemplary embodiment of the present inventive concept.

FIG. 7 is a plane layout view of a pixel of the curved display device of FIG. 6.

FIG. 8 is a cross-sectional view taken along a line VIII-VIII of FIG. 6.

### DETAILED DESCRIPTION OF THE EMBODIMENTS

The present inventive concept will be described more fully hereinafter with reference to the accompanying drawings, in which exemplary embodiments of the inventive concept are shown. As those skilled in the art would realize, the described embodiments may be modified in various different ways, all without departing from the spirit or scope of the present inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present between the element and the another element. In contrast, when an element is referred to as being “directly on” another element, there are no intervening elements present between the element and the another element.

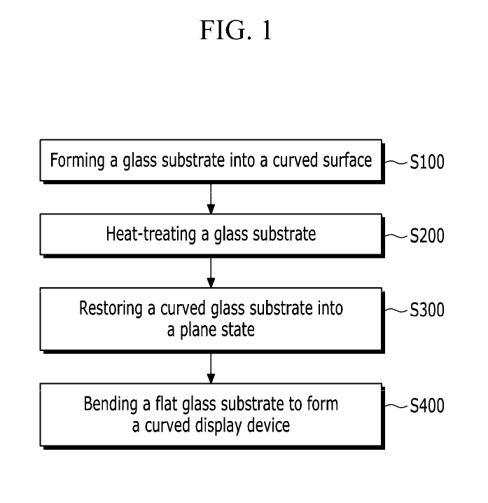

Now, a manufacturing method of a curved display device according to an exemplary embodiment of the present inventive concept will be described with reference to FIG. 1 to FIG. 4.

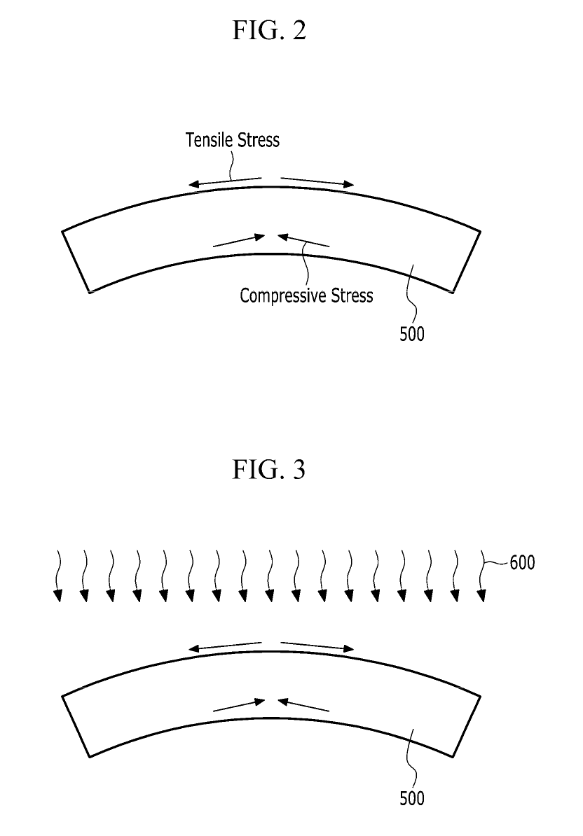

FIG. 1 is a flowchart sequentially showing a manufacturing method of a curved display device according to an exemplary embodiment of the present inventive concept, and FIGS. 2 to 4 are views sequentially showing a manufacturing method of a curved display device according to an exemplary embodiment of the present inventive concept.

Referring to FIG. 1 and FIG. 2, a glass substrate 110 is bent to form a curved surface (S100). In this case, the curved surface is formed by bending the glass substrate 110 of a quadrangle shape with reference to any one axis, however it is not limited thereto, and the glass substrate 110 may be bent with reference to multiple axes.

At this time, in the glass substrate 110, a tensile stress is generated from an outside surface to an outer portion of the glass substrate 110 and a compression stress is generated from an inside surface of the glass substrate 110 to a center of the glass substrate 110.

Here, the outside surface of the glass substrate 110 means a surface having a convex shape, and the inside surface of the glass substrate 110 means a surface having a concave shape.

The tensile stress means a resistance force (kg/mm²) that is generated inside a material against an external force when the substrate 110 is expanded by receiving the external force. The tensile stress may be equal to the external force. When considering a surface of an object, the tensile stress means a case that the force like pushing the surface at both sides acts.

Next, referring to FIG. 1 and FIG. 3, a heat treatment 600 is performed to the outside surface of the glass substrate 110 in which the tensile stress is generated in the glass substrate 110 (S200).

The heat treatment 600 may use various methods such as dry, wet, high frequency, or laser heat treatment, and a means of the heat treatment 600 is not limited thereto.

In general, in the case of the glass substrate 110, a crack is easily generated in a portion where the tensile stress is applied, and a source of energy through which the glass substrate 110 is completely broken is also the tensile stress. Accordingly, the heat treatment 600 is performed to the outside surface of the glass substrate 110 in which the tensile stress is generated. The heat treatment 600 is not performed to the inside surface of the glass substrate 110 in which the compression stress is generated, thereby relaxing the tensile stress.

The crack may not only be prevented from being generated in the glass substrate 110 or may be delayed by relaxing the tensile stress, but the energy growing the crack may be previously ameliorated or removed through the heat treatment 600, thereby enhancing the durability and the reliability of the glass substrate 110.

In detail, as a wet heat treatment 600, the heat treatment 600 may be performed through a water vapor, and in this case, the heat treatment may be performed in a temperature of about 200-600° C. for about 10-30 minutes, however the temperature or the time is not limited thereto and may be variously changed.

As a dry heat treatment 600, the heat treatment 600 may use a radiant heat. The dry heat treatment 600 may be performed in a temperature of about 600-800° C. that is higher than that of the wet heat treatment 600 for about 10-30 minutes, however the temperature or the time is not limited thereto and may be variously changed.

The heat treatment 600 may be performed using a high frequency treatment such as a variable frequency microwave (VFM) treatment and a laser treatment.

For the heat treated glass substrate 110 as described, a glass surface strength may be more than 200 MPa and a glass edge strength may be more than 120 MPa.

Finally, referring to FIG. 1 and FIG. 4, the heat treated glass substrate 110 is restored back to the flat state (S300). The outside surface of the substrate may have a compressive stress after restoring the curved glass substrate into a flat state.

This is because the curved shaped glass substrate is hard to handle during a manufacture process, thus the curved shaped glass substrate may cause many problems due to its curved shape such as increase in manufacturing cost and defect.

Forming display elements such as a driving circuit, an organic light emitting element and an encapsulation substrate are formed on the glass substrate restored back to the flat state.

Next, to form the curved display device, the glass substrate 110 is bent according to a required radius of curvature (S400).

As described above, since the tensile stress is relaxed or removed in the glass substrate 110 during the heat treatment 600 in the curved state, the state of stress relief may be maintained although the glass substrate 110 is restored to the flat state and is again curved.

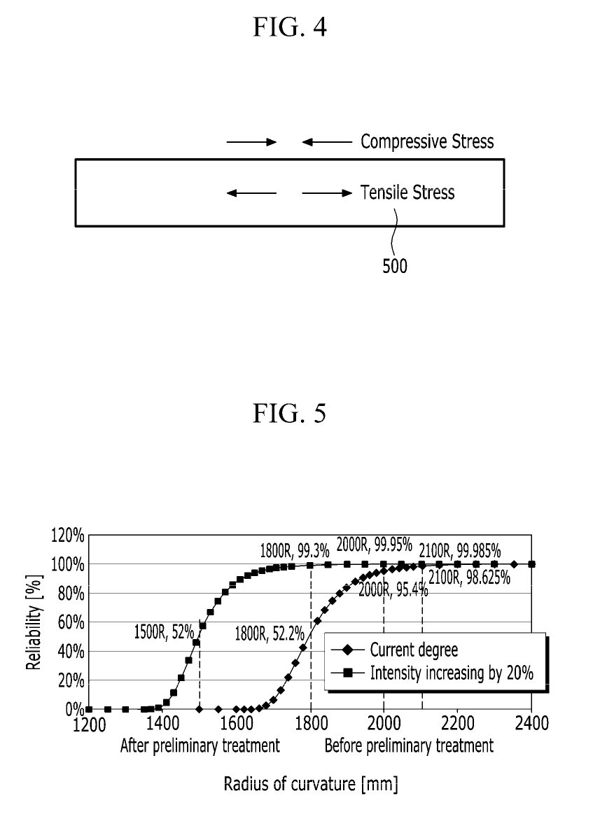

Next, a test result of durability and reliability of the glass substrate according to an exemplary embodiment of the present inventive concept will be described with reference to FIG. 5.

FIG. 5 is a graph showing test results of a curved display device according to an exemplary embodiment of the present inventive concept.

A vertical axis indicates reliability, for example, when bending the glass substrate 110 according to a predetermined radius of curvature by a certain number. The reliability is a percent of glass substrates 110 in which the crack is not generated. The horizontal axis indicates a radius of curvature (mm) of the curved glass substrate 110.

Referring to FIG. 5, in the case of the glass substrate 110 without the preliminary heat treatment 600, the crack is generated when the curvature radius is only about 2100 mm, thereby the reliability is decreased.

In contrast, in the case of the glass substrate 110 provided with the preliminary heat treatment 600, the glass substrate 110 is hardly damaged with reliability of 99.9% at a curvature radius of 2100 mm, and even if the radius of curvature is reduced to 1800 mm, reliability of 99.3% is exhibited.

Accordingly, in the glass substrate 110 with the preliminary heat treatment 600, it may be confirmed that the display panel having smaller radius of curvature may be realized without a defect such as a crack and the reliability and the durability of the display panel may also be improved.

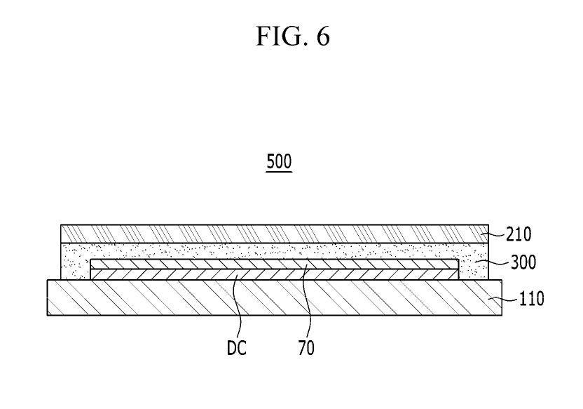

Hereinafter, the structure of the display device applied with the glass substrate 110 according to an exemplary embodiment of the present inventive concept will be described with reference to FIG. 6 to FIG. 8.

For convenience, an organic light emitting device (OLED) is provided as an example, however it is not limited thereto as long as the preliminary heat-treated glass substrate according to an exemplary embodiment of the present inventive concept is used. The display device may be a liquid crystal display (LCD) rather than the organic light emitting diode display.

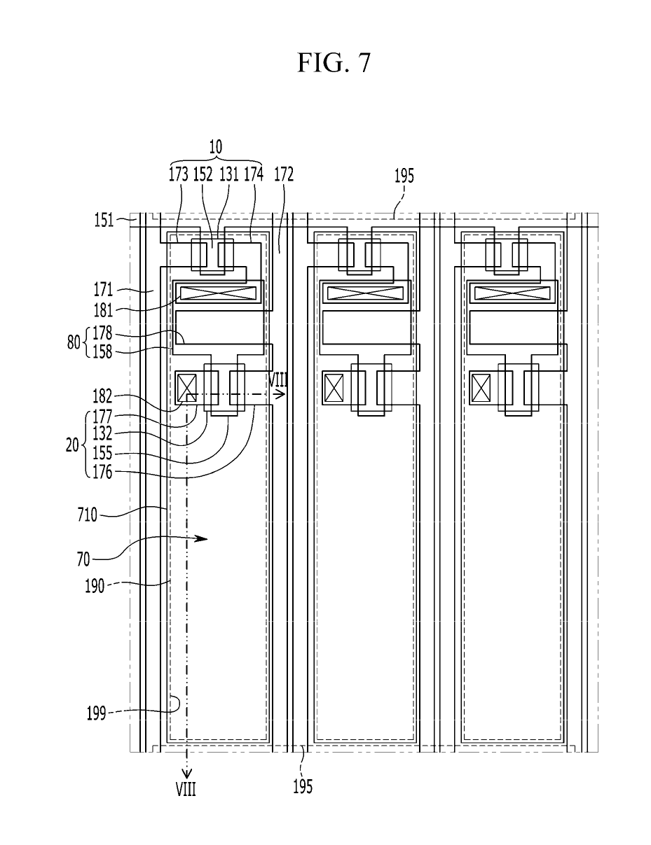

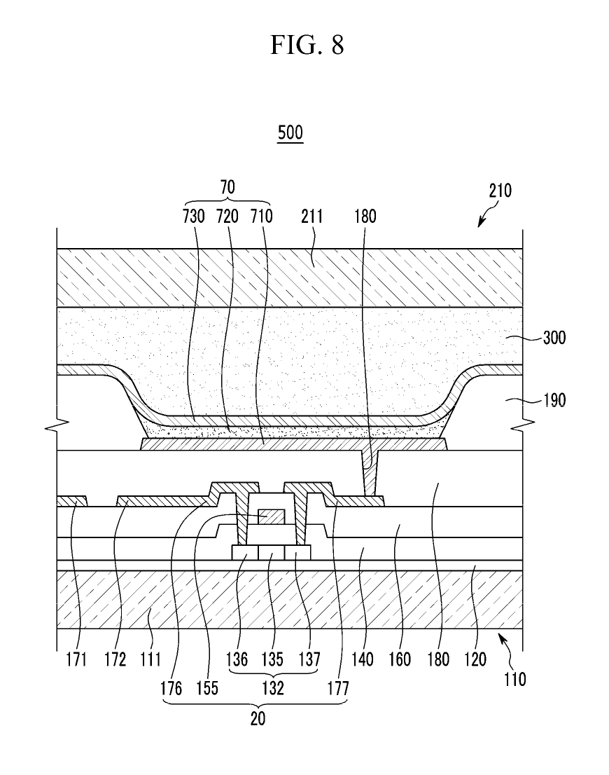

FIG. 6 is a schematic cross-sectional view of a curved display device according to an exemplary embodiment of the present inventive concept, FIG. 7 is a plane layout view of a pixel of the curved display device of FIG. 6, and FIG. 8 is a cross-sectional view taken along a line VIII-VIII of FIG. 7.

First, referring to FIG. 6, the organic light emitting panel 500 according to the present exemplary embodiment includes a glass substrate 110 and an encapsulation substrate 210 corresponding thereto, and they are adhered by a sealant 300.

The glass substrate 110 is used to display an image, and an organic light emitting element 70 and a driving circuit DC including a thin film transistor to drive the organic light emitting element 70 are formed on the glass substrate 110. The encapsulation substrate 210 seals the glass substrate 110 to protect the organic light emitting element 70, and the encapsulation substrate 210 is formed of a metal in the present exemplary embodiment.

Next, referring to FIG. 7 and FIG. 8, a 2Tr-1Cap active matrix (AM) type of organic light emitting panel having two thin film transistors (TFTs) and a capacitor for each pixel is shown, but the present inventive concept is not limited thereto. Accordingly, the organic light emitting panel can have various structures, for example, three or more TFTs and two or more capacitors can be provided in one pixel, and the arrangement of the wiring may be changed. Here, the pixel means a minimum unit that displays an image, and the organic light emitting diode (OLED) display displays an image through a plurality of pixels.

The glass substrate 110 includes a switching thin film transistor 10, a driving thin film transistor 20, a capacitor 80, and an organic light emitting element 70 for each pixel. In addition, the glass substrate 110 further includes a gate line 151 that is disposed along a predetermined direction, and a data line 171 and a common electric power line 172 that insulatingly cross the gate line 151.

The organic light emitting element 70 includes a pixel electrode 710, an organic emission layer 720 formed on the pixel electrode 710, and a common electrode 730 formed on the organic emission layer 720. In the exemplary embodiment, the pixel electrode 710 is an anode that is a hole injection electrode and the common electrode 730 is a cathode that is an electron injection electrode, but the present inventive concept is not limited thereto. Holes and electrons are injected from the pixel electrode 710 and the common electrode 730 to the organic emission layer 720. When an exciton, that is a combination of the injected hole and electron, falls from an exited state to a ground state, light emission occurs.

The capacitor 80 includes a first capacitor plate 158 and a second capacitor plate 178 that are disposed with a gate insulating layer 140 therebetween that acts as a dielectric material. The capacitance of the capacitor is determined by the charge that is accumulated in the capacitor 80 and the voltage between both capacitor plates 158 and 178.

The switching thin film transistor 10 includes a switching semiconductor layer 131, a switching gate electrode 152, a switching source electrode 173, and a switching drain electrode 174, and the driving thin film transistor 20 includes a driving semiconductor layer 132, a driving gate electrode 155, a driving source electrode 176, and a driving drain electrode 177. The switching thin film transistor 10 is a switching element that selects the pixel that emits light. The switching gate electrode 152 is connected to the gate line 151, the switching source electrode 173 is connected to the data line 171, and the switching drain electrode 174 is spaced apart from the switching source electrode 173 and connected to the first capacitor plate 158.

The driving thin film transistor 20 applies a driving power for emitting light of the organic emission layer 720 of the organic light emitting diode 70 to the pixel electrode 710 in the selected pixel. The driving gate electrode 155 is connected to the first capacitor plate 158, the source electrode 176 and the second capacitor plate 178 are connected to the common power line 172, and the driving drain electrode 177 is connected to the pixel electrode 710 of the organic light emitting element 70 through a contact hole 182.

With the above-described structure, the switching thin film transistor 10 is driven to transmit a data voltage applied to the data line 171 to the driving thin film transistor 20 according to a gate voltage applied to the gate line 151. A voltage that corresponds to a voltage difference between a common voltage transmitted from the common power line 172 to the driving thin film transistor 20 and the data voltage transmitted from the switching thin film transistor 10 is stored in the capacitor 80, and a current corresponding to the voltage stored in the capacitor 80 flows to the organic light emitting element 70 through the driving thin film transistor 20 so that the organic light emitting element 70 emits light.

Hereinafter, the organic light emitting panel according to the present exemplary embodiment will be described according to a lamination order.

A glass substrate 110 is formed of a transparent insulating substrate, and in the present exemplary embodiment, the glass substrate is formed of a glass which is heat treated according to the process as disclosed in FIG. 1.

The glass substrate 110 of the organic light emitting panel according to an exemplary embodiment of the present inventive concept is manufactured through the above-described preliminary heat treatment.

The description of the preliminary heat treatment is the same as described above such that the repeated description is omitted.

A buffer layer 120 is formed with silicon nitride (SiNx), silicon oxide (SiOx), silicon oxynitride (SiOxNy) on the glass substrate 110, and may be omitted according to the material and the processing condition of the glass substrate 110.

The driving semiconductor layer 132 is formed on the buffer layer 120. The driving semiconductor layer 132 includes a channel region 135 in which an impurity is not doped, and a source region 136 and a drain region 137 that are p+ doped and disposed on both ends of the channel region 135. In this case, the doped ion material is a P-type impurity such as boron (B).

In the exemplary embodiment, a thin film transistor that has a PMOS structure that uses the P-type impurity as the driving thin film transistor 20 is used, but the present inventive concept is not limited thereto, and a thin film transistor that has an NMOS structure or a CMOS structure may be used. In addition, in the exemplary embodiment, the driving thin film transistor 20 is a polycrystalline thin film transistor that includes a polysilicon film, but a switching thin film transistor 10 not shown in FIG. 3 may be a polycrystalline thin film transistor or amorphous thin film transistor that includes an amorphous silicon film.

The gate insulating layer 140 that is formed of a silicon nitride or a silicon oxide is formed on the driving semiconductor layer 132. The gate wire that includes the gate electrode 155 is formed on the gate insulating layer 140, and the gate wire further includes the gate line 151, the first capacitor plate 158, and the other wires. In addition, the driving gate electrode 155 is formed so as to overlap at least a portion of the driving semiconductor layer 132, particularly the channel region 135.

An interlayer insulating layer 160 covering the driving gate electrode 155 is formed on the gate insulating layer 140, and the gate insulating layer 140 and the interlayer insulating layer 160 have a hole exposing the source region 136 and the drain region 137 of the semiconductor layer 132. The interlayer insulating layer 160 is formed of a silicon nitride or a silicon oxide like the gate insulating layer 140.

A data wire that includes the driving source electrode 176 and the driving drain electrode 177 is formed on the interlayer insulating layer 160, and the data wire further includes the data line 171, the common power line 172, the second capacitor plate 178, and the other wires. In addition, the driving source electrode 176 and the driving drain electrode 177 are connected to the source region 136 and drain region 137 of the driving semiconductor layer 132 through the holes that are formed on the interlayer insulating layer 160 and the gate insulating layer 140.

The driving semiconductor layer 132, the driving gate electrode 155, the driving source electrode 176, and the driving drain electrode 177 are formed as described above, but the configuration of the driving thin film transistor 20 is not limited to the above examples and may be variously modified by those who are skilled in the art.

A planarization layer 180 that covers a data wire is formed on the interlayer insulating layer 160, and the contact hole 182 that exposes a portion of the drain electrode 177 is formed in the planarization layer 180. Either one of the interlayer insulating layer 160 or planarization layer 180 may be omitted.

The pixel electrode 710 of the organic light emitting diode 70 is formed on the planarization layer 180, and the pixel electrode 710 is connected to the drain electrode 177 through the contact hole 182. In addition, a pixel definition film 190 that has a plurality of openings 199 that expose each pixel electrode 710 is formed on the planarization layer 180. The portion on which the pixel definition film 190 is formed substantially becomes a non-light emitting area, and the portion on which the opening 199 of the pixel definition film 190 is formed substantially becomes a light emitting area.

The organic emission layer 720 is formed on the pixel electrode 710 corresponding to the light emitting area, and the common electrode 730 is formed on the organic emission layer 720, thereby constituting the organic light emitting diode 70. The organic emission layer 720 is formed of a low molecular organic material or high molecular organic material, and the organic emission layer 720 may be formed of a multilayer that includes one or more of a hole injection layer (HIL), a hole transport layer (HTL), an electron transport layer (ETL), and an electron injection layer (EIL).

On the other hand, the organic light emitting panel according to the present exemplary embodiment is formed of a bottom emission type, so as to emit the light in the direction of the glass substrate 110. Accordingly, in the present exemplary embodiment, the pixel electrode 710 is formed of a transparent conductive material, and the transparent conductive material may be ITO (indium tin oxide) or IZO (indium zinc oxide). In the bottom emission type, to increase emission efficiency, the common electrode 730 may be formed of a reflective conductive material, and the reflective conductive material may be aluminum (Al), silver (Ag), magnesium (Mg), or alloys thereof.

The encapsulation substrate 210 is formed on the common electrode 730 to face the glass substrate 110, and the two substrates 110 and 210 are adhered through the sealant 300 interposed therebetween.

In the present exemplary embodiment, the encapsulation substrate 210 is formed of the metal to seal and protect the organic light emitting element 70. The material forming the encapsulation substrate 210 may be aluminum, copper, stainless steel, titanium, tungsten, invar, or a carbon composite material. As described above, by forming the encapsulation substrate 210 of the metal, the encapsulation substrate 210 may be formed with a thin thickness, thereby realizing the slim organic light emitting panel.

The glass substrate 110 and the encapsulation substrate 210 are adhered through the sealant 300. The sealant may be a thermal hardening resin such as an epoxy resin may be used.

As described above, the curved display device according to an exemplary embodiment of the present inventive concept performs the preliminary heat treatment to the glass substrate, thereby improving the durability and the reliability of the curved panel.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A method for manufacturing a curved display device, comprising:
bending a substrate to form a curved surface;
heat-treating the substrate formed with the curved surface;
restoring the heat-treated substrate into a flat state;
forming display elements on the substrate; and bending the substrate of the flat state to form the curved surface.

2. The method of claim 1, wherein
the substrate is made of a glass.

3. The method of claim 2, wherein
in the step of heat-treating the substrate, the surface where a tensile stress is generated is heat-treated.

4. The method of claim 3, wherein
in the step of heat-treating the substrate, a convex surface of the substrate is heat-treated.

5. The method of claim 3, wherein
the heat treatment of the substrate is a wet heat treatment.

6. The method of claim 5, wherein
the wet heat treatment uses a vapor.

7. The method of claim 6, wherein
the wet heat treatment using the vapor is performed at a temperature of about 200-600° C.

8. The method of claim 7, wherein
the wet heat treatment using the vapor is performed for about 10-30 minutes.

9. The method of claim 3, wherein
the heat treatment of the substrate is a dry heat treatment.

10. The method of claim 9, wherein
the dry heat treatment uses radiation heat.

11. The method of claim 10, wherein
the dry heat treatment is performed at a temperature of about 600-800° C.

12. The method of claim 11, wherein
the dry heat treatment using the radiation heat is performed for about 10-30 minutes.

13. The method of claim 3, wherein
the heat-treating of the substrate is a high frequency treatment.

14. The method of claim 13, wherein
the high frequency treatment uses a variable frequency microwave (VFM) or a laser.

15. A method for manufacturing a curved display device, comprising:
bending a glass substrate to form a curved surface;
heat-treating a surface in which a tensile stress is generated in the glass substrate formed of the curved surface;
restoring the heat-treated glass substrate to a flat state;
forming display elements on the glass substrate; and
bending the substrate of the flat state to form the curved surface.

16. The method of claim 15, wherein
the heat treatment of the substrate is performed at a temperature of about 200-600° C. for about 10-30 minutes in a vapor.

17. The method of claim 15, wherein
the heat treatment of the substrate is performed at a temperature of about 600-800° C. for about 10-30 minutes by using radiation heat.

18. The method of claim 15, wherein
the heat treatment of the substrate uses a variable frequency microwave (VFM) or a laser.
